(19) United States
(12) Patent Application Publication
(10) Pub. No.: US 2005/0191014 A1
(43) Pub. Date: Sep. 1, 2005

(54) Fiber optic splice component

(76) Inventors: James G. Renfro JR., Hickory, NC (US); Bryan R. Roark, Conover, NC (US)

Correspondence Address: CORNING CABLE SYSTEMS LLC, P O BOX 489, HICKORY, NC, 28603, US

(21) Appl. No.: 10/790,537

(22) Filed: Mar. 1, 2004

(51) Int. Cl. G02B 6/255

(52) U.S. Cl. 385/99; 385/55; 385/58; 385/60; 385/66; 385/95; 385/96; 385/97; 385/98

(57) ABSTRACT

A fiber optic splice component is provided with a ferrule having an opening therein, a housing to hold the ferrule, and at least one electrode in the housing for fusing optical fibers inserted into the opening. A method and machine to fuse optical fibers in a fiber optic splice component is also provided, with the method and machine being capable of melting a protection element around the fused optical fibers. A splicing ferrule with a lead-in portion at each end of the ferrule is also provided.

### FIELD OF THE INVENTION

The present invention relates to a fiber optic splice component and method for fusing optical fibers in the fiber optic splice component. More particularly, the invention is a fiber optic splice component that allows splicing of the optical fibers and sealing of the splice in a single component or a single machine.

### BACKGROUND OF THE INVENTION

There are prior art fiber optic splice components and methods for fusion splicing optical fibers and sealing a fiber optic splice. However, the components and methods do not allow for splicing and sealing the splice in a single fiber optic splice component or with a single machine.

Accordingly, the present invention is directed to a fiber optic splice component and machine that substantially obviates one or more of the problems and disadvantages in the prior art. Additional features and advantages of the invention will be set forth in the description that follows, and in part will be apparent from the description, or may be learned by practice of the invention. These objectives and other advantages of the invention will be realized and attained by the fiber optic splice component, machine and method particularly pointed out in the written description and accompanying drawings, as well as the appended claims.

### SUMMARY OF THE INVENTION

To achieve these and other advantages and in accordance with the purpose of the invention as embodied and broadly described herein, the invention is directed to a fiber optic splice component that includes a ferrule having a passageway extending from a first end to a second end thereof to hold an optical fiber inserted from each end and having an opening between the first and second ends in communication with the passageway, a housing, the housing configured to hold the ferrule therein, and at least one electrode disposed in the housing and adjacent to the opening in the ferrule for fusion splicing the optical fibers.

In another aspect, the invention provides a ferrule to be used in a fiber optic splice component that includes a body having a first end and a second end, the body having a lead-in portion at the first end and at the second end, a passageway extending from the first end to the second end of the body to hold an optical fiber inserted from each end, and an opening disposed between the first and second ends in communication with the passageway to be used in splicing the optical fibers.

In yet another aspect, the invention provides a method for splicing two optical fibers in a fiber optic splice component that includes the steps of providing the fiber optic splice component, the fiber optic splice component comprising a ferrule having a passageway extending from a first end to a second end to hold an optical fiber inserted from each end and having an opening between the first and second ends in communication with the passageway, a housing, and at least one electrode disposed in the housing adjacent to the opening in the ferrule for fusion splicing the optical fibers, inserting the optical fibers into respective ends of the fiber optic splice component, initiating a fiber optic splice machine, the splice machine applying a voltage to the electrodes to cause an arc to be generated across the opening of the ferrule thereby fusing the optical fibers, and heating a splice protective element disposed in the housing to melt and form around the fused optical fibers.

In another aspect, the invention provides a fiber optic splice machine that includes a base portion, the base portion including a fiber optic splice holder for holding at least a portion of a fiber optic splice component, electrical contacts adjacent the fiber optic splice holder and in communication with an arc generator, a heating element disposed under the fiber optic splice holder, and a top portion hingedly connected to the base portion and configured to hold a top portion of the fiber optic splice component.

It is to be understood that the foregoing general description and the following detailed description are merely exemplary and explanatory and are included for the purpose of providing further understanding of the invention as claimed.

The accompanying drawings are likewise included to provide a further understanding of the invention and are incorporated in and constitute a part of the specification. The drawings illustrate several embodiments of the invention and together with the written descriptions serve to explain the principles of the invention.

### BRIEF DESCRIPTION OF THE DRAWINGS

FIG. 1 is an exploded view of an exemplary embodiment of a fiber optic splice component according the present invention;

FIG. 2 is a lateral cross section view of the fiber optic splice component of FIG. 1;

FIG. 3a is a schematic illustration of opposed optical fibers being inserted into the fiber optic splice component of FIG. 1;

FIG. 3b is a schematic illustration of the opposed optical fibers in the area of splicing in the fiber optic splice component of FIG. 1;

FIG. 3c is a schematic illustration of the opposed optical fibers being spliced in the fiber optic splice component of FIG. 1;

FIG. 3d is a schematic illustration showing a splice protection element aligned with the spliced optical fibers;

FIG. 3e is a schematic illustration of the fiber optic splice component after the splicing and sealing operations are performed;

FIG. 4 is an exemplary embodiment of a machine used to splice and protect a fiber optic splice in a fiber optic splice component according the present invention;

FIG. 5 is a lateral cross section view of the machine of FIG. 4; and

FIG. 6 is a partial top view of another exemplary embodiment of a machine to splice and protect a fiber optic splice in a fiber optic splice component according to the present invention.

### DETAILED DESCRIPTION OF THE INVENTION

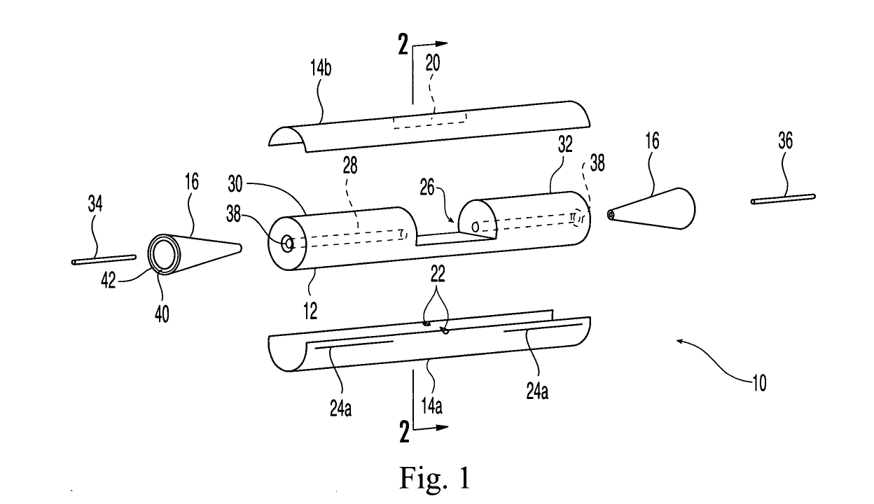

FIG. 1 illustrates an exemplary embodiment of a fiber optic splice component 10. The fiber optic splice component 10 is preferably preassembled, with the ferrule 12 already placed in the bottom portion 14a of the housing. The bottom portion 14a also retains the strain relief elements 16 on either end of the ferrule 12. The fiber optic splice component 10 also has a top portion 14b of the housing with a protection element 20 disposed therein.

The housing is illustrated as having a generally cylindrical configuration. However, the housing could be of any desired configuration, including, for example, rectangular, oval, etc. The housing preferably made from plastic, but could be made from any appropriate material, including metal. The bottom portion 14a preferably has two electrodes 22 on either side of the ferrule 12. The electrodes 22 may be attached to the top edge of the bottom portion 14a or may be integral with the bottom portion 14a and protrude inwardly through the housing. The bottom portion 14a may also have ribs 24a attached to an outer surface thereof to allow for corresponding structure on the top portion 14b to assist in joining the bottom portion 14a with the top portion 14b. Other methods of joining the two housing portions 14a, 14b together would also be within the scope of the present invention. Such methods could include a hinge, projections/recesses, etc.

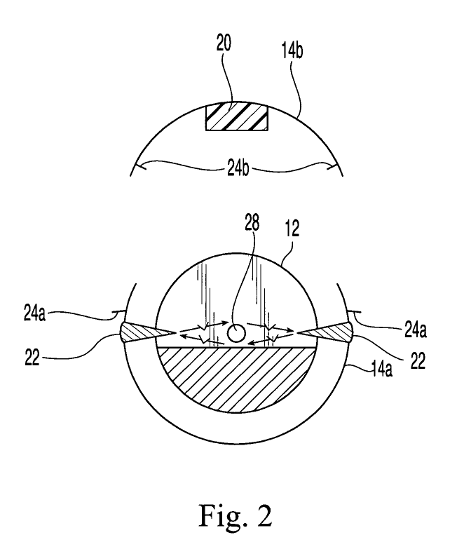

The ferrule 12 is preferably disposed in the bottom portion 14a prior to use. The ferrule 12 has an opening 26, preferably near the center (from either end) of the ferrule 12. The opening 26 allows access to a passageway 28 that extends from a first end 30 to a second end 32 of the ferrule 12. The opening 26 is large enough to allow the electrodes 22 access to the optical fibers 34, 36 for fusing. As can be seen in FIG. 2, the opening 26 extends slightly more than 180° around the ferrule 12 to fully expose the optical fibers 34, 36 extending from passageway 28. However, the opening 26 may be greater or less than 180°, depending on the locations of the electrodes 22 and the need to expose the entire circumferences of the optical fibers 34, 36 to the electrical arc generated between the electrodes 22. The opening 26 need only be sufficient to allow access by the electrodes 22 and the generated arc to the extent necessary to fuse the optical fibers 34, 36. The ferrule 12 also preferably has a lead-in portion 38 on both the first end 30 and the second end 32. The lead-in portion is larger at the very end of the ferrule 12 and narrows to about the same diameter as the passageway 28 through the ferrule 12. The ferrule 12 can be made from thermoset, thermoplastic, or ceramic materials.

The top portion 14b has a protection element 20 disposed therein. The protection element 20 is typically EVA or some other heat sensitive material that provides similar melt and flow properties. The protection element 20 will be melted and will flow around the fused optical fibers in the ferrule 12 to provide further protection of the splice. The top portion 14b may also have ribs 24b as shown in FIG. 2 that engage the corresponding ribs 24a on the bottom portion 14a.

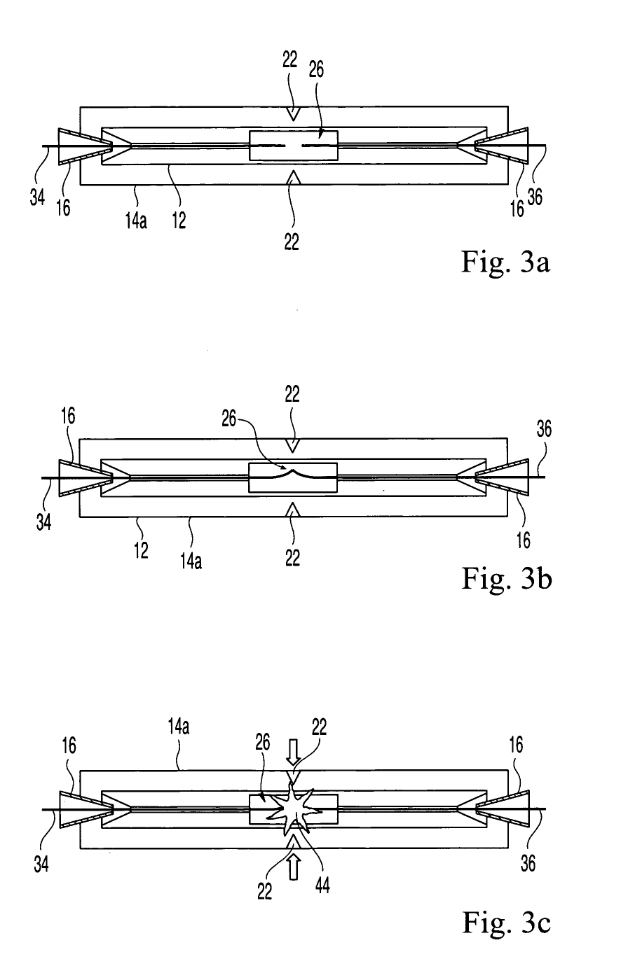

The strain relief elements 16 are used to provide strain relief for the optical fibers 34, 36. While the strain relief elements 16 are illustrated to be frustoconical in shape, they may be of any configuration. However, the strain relief elements 16 preferably function as a lead-in for the optical fibers 34, 36 into ferrule 12. As illustrated best is FIGS. 3a-3e, the inside diameter of each strain relief element 16 is preferably larger at the end away from the ferrule 12 and is narrower at the end toward the ferrule 12. While not necessary, the configuration of the strain relief elements 16 is helpful in guiding the optical fibers 34, 36 into the lead-in portion 38 of the ferrule 12. In fact, the strain relief elements 16 could be cylindrical with constant inner and outer diameters and still be within the scope of the present invention. The strain relief elements 16 preferably have two layers. A first layer 40 made of EVA or other heatable material to provide adhesion around the optical fibers 34, 36 and to hold the second layer 42. The second layer 42 is a polyolefin that provides abrasion resistance to further protect the optical fibers. The second layer 42 may also provide some moisture protection to the fiber optic splice component 10. The two layer material for the strain relief elements 16 may be obtained from INSULTAB, Inc. of Woburn, Mass.

The fusion of the optical fibers in the fiber optic splice component 10 will now be described with reference to FIGS. 3a-3e. A fiber optic splice component 10 has an optical fiber 34, 36 inserted from either end. The optical fibers 34, 36 pass through the strain relief elements 16 and into the passageway 28 via the lead-in portions 38 of the ferrule 12. Eventually, the optical fibers 34, 36 pass into the opening 26. As illustrated in FIG. 3b, the operator may then advance the optical fibers 34, 36 until they are engaged in the opening 26. While the ends of the optical fibers 34, 36 are illustrated to be in the center of opening 26, they need not be located exactly at the center of the opening. However, the closer the optical fibers 34, 36 are to the center of the opening 26 (or wherever the electrodes 22 are located), the better the fusion splice will be. An arc 44, as illustrated in FIG. 3c, is generated through the electrodes 22, causing the optical fibers 34, 36 to be fused. After the optical fibers 34, 36 are fused together, as shown in FIG. 3d, the protection element 20 is placed over the fused optical fibers and heated. The melted protection element 20 then flows around the fused optical fibers 34, 36 and fills at least a portion of the opening 26. At the same time the protection element 20 is being heated, the strain relief elements 16 are also being heated. Since the strain relief elements 16 are preferably made from the same material as the protection element 20, they too will soften and form around the optical fibers 34, 36 at either end of the fiber optic splice component 10. It should be noted that the strain relief elements 16 may be moved along the optical fibers 34, 36 to a location that is best suited for the particular application and do not have to be located where illustrated in the figures.

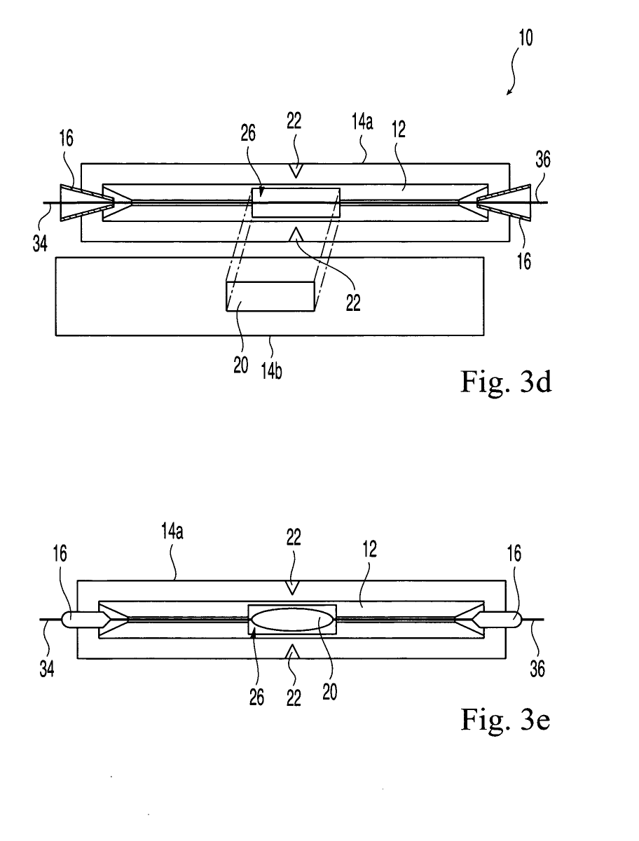

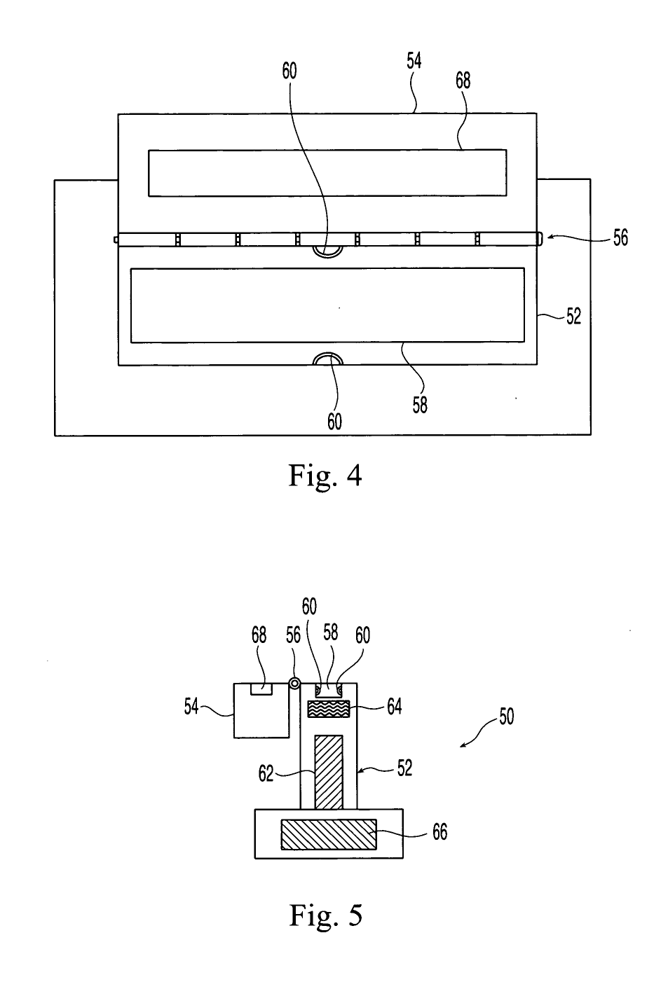

An exemplary embodiment of a machine 50 to splice and heat the fiber optic splice component 10 is illustrated in FIGS. 4 and 5. The machine 50 has a base portion 52 and a top portion 54 preferably connected by a hinge 56. The base portion 52 has a fiber optic splice holder 58 located therein for receiving a fiber optic splice component, which may be the same as that disclosed above, but may also be of a different configuration. The fiber optic splice holder 58 has adjacent electrical contacts 60 to engage the electrodes 22 in the fiber optic splice component 10. The base portion 52 also has an arc generator 62 (FIG. 5) that is in electrical communication with the electrical contacts 60 that engage the electrodes 22 to fuse the optical fibers 34, 36.

Also present in the base portion 52 is a heating element 64 (FIG. 5). The heating element 64 is preferable disposed directly under the fiber optic splice holder 58 in order to most efficiently heat the fiber optic splice component 10 and thereby melt the protection element 20 and the strain relief elements 16. Typically the heating element 64 begins heating once the optical fibers 34, 36 have been fused. However, depending on the type of heating element used and the time required for the protection element 20 to come to temperature and the strain relief elements 16 to melt, the heating element 64 may begin heating at the same time or even before the splicing of the optical fibers 34, 36. The sequence of splicing the optical fibers 34, 36 and heating the fiber optic splice component 10 may be initiated by the operator pressing a button or by simply closing the top portion 54 once the fiber optic splice component 10 is inserted into the machine 50.

The base portion 52 also has a battery 66 to energize the arc generator 62 and the heating element 64. The battery 66 is preferably a rechargeable battery that can be recharged in a charger or by a 12 VDC source, such as in a vehicle.

The top portion 54 of the machine 50 has an opening 68 therein for receiving the top portion 14b of the fiber optic splice component 10. The top portion 14b can be inserted into and held within the opening 68, for example by a loose press fit, until an electrical arc is generated between the electrodes 22 of the fiber optic splice component 10 and the optical fibers 34, 36 are fused together. The top portion 14b can then be removed from the opening 68 and secured to the bottom portion 14a, as previously described. Alternatively, the top portion 14b may be secured to the bottom portion 14a when the top portion 54 of the machine 50 is rotated about the hinge 56 and closed onto the base portion 52.

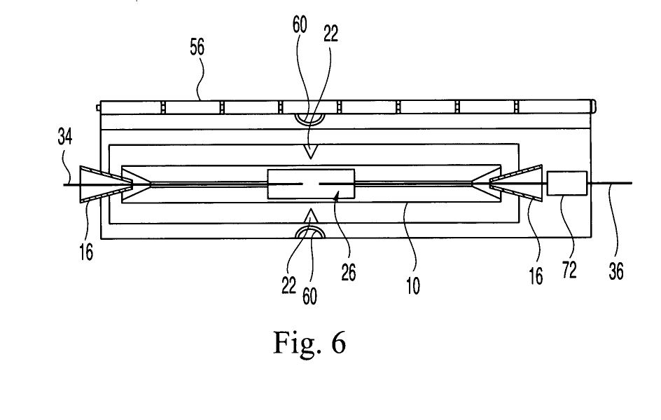

FIG. 6 illustrates another exemplary embodiment of a splice machine 70, which is similar to the prior embodiment. However, included in this embodiment of machine 70 is a clamping mechanism 72 that holds at least one of the optical fibers 34, 36. For example, the operator inserts the optical fiber 36 into the clamping mechanism 72, which closes around the optical fiber 36. The clamping mechanism 72 then moves relative to the fiber optic splice component 10 and inserts the optical fiber 36 into the opening 26 in the correct location for fusion splicing the two optical fibers 34, 36 together. The clamping mechanism 72 may be moved by virtue of a piezo-driven mechanism in a known manner. However, the clamping mechanism may also be driven by a spring-loaded mechanism. Typically, the clamping mechanism 72 initially inserts the optical fiber 36 into the opening 26 such that a small gap remains between the optical fibers 34, 36 so that the ends of the optical fibers may be cleaned or otherwise processed prior to fusing. The clamping mechanism 72 then operates to move the end of the optical fiber 36 into physical engagement with the end of the optical fiber 34 during the fusing process. However, the clamping mechanism 72 may also operate to insert the optical fiber 36 into the opening 26 such that the ends of the optical fibers 34, 36 are initially in physical engagement, or are even pre-loaded. Regardless, the clamping mechanism 72 preferably biases the end of the optical fiber 36 against the end of the optical fiber 34 as the optical fibers 34, 36 are fused together to avoid the formation of any void between the optical fibers.

It will be apparent to those skilled in the art that various modifications and variations can be made in the fiber optic splice component and method for fusing optical fibers of the present invention without departing from the spirit or scope of the invention. Thus, it is intended that the present invention cover the modifications and variations of this invention provided they come within the scope of the appended claims and their equivalents.

1. A fiber optic splice component comprising:
a ferrule having a passageway extending from a first end to a second end thereof for receiving an optical fiber inserted from each end and having an opening between the first and second ends in communication with the passageway;
a housing, the housing configured to hold the ferrule therein; and
at least one electrode disposed in the housing and adjacent to the opening in the ferrule for fusion splicing the optical fibers.

2. The fiber optic splice component of claim 1 further comprising a protection element to seal the fusion spliced optical fibers.

3. The fiber optic splice component of claim 1 wherein the protection element is a heat shrink element.

4. The fiber optic splice component of claim 1 further comprising a strain relief element disposed in the housing.

5. The fiber optic splice component of claim 1 further comprising a lead-in portion adjacent one of the first end and the second end to guide the optical fibers into the passageway.

6. The fiber optic splice component of claim 1 further comprising a strain relief element disposed in the housing and a lead-in portion adjacent one of the first end and the second end and disposed in the strain relief element.

7. The fiber optic splice component of claim 1 further comprising a lead-in portion in the ferrule at each of the first end and the second end.

8. A ferrule adapted for use in a fiber optic splice component comprising:
a body having a first end and a second end, the body having a lead-in portion at the first end and at the second end;
a passageway extending from the first end to the second end of the body to position an optical fiber inserted from each end; and
an opening disposed between the first and second ends in communication with the passageway to splice the optical fibers together.

9. A method for splicing two optical fibers together in a fiber optic splice component comprising:
providing the fiber optic splice component, the fiber optic splice component comprising a ferrule having a passageway extending from a first end to a second end to position an optical fiber inserted from each end and having an opening between the first and second ends in communication with the passageway, a housing, and at least one electrode disposed in the housing adjacent to the opening in the ferrule for fusion splicing the optical fibers;
inserting the optical fibers into respective ends of the fiber optic splice component;
initiating a fiber optic splice machine, the splice machine:
applying a voltage to the electrodes to cause an arc to be generated across the opening of the ferrule thereby fusing the optical fibers; and
heating a splice protection element disposed in the housing to melt and form around the fused optical fibers.

10. The method for splicing two optical fibers in a fiber optic splice component of claim 9, wherein the applying and heating steps are initiated simultaneously.

11. The method for splicing two optical fibers in a fiber optic splice component of claim 9, wherein the applying and heating steps are initiated in series.

12. The method for splicing two optical fibers in a fiber optic splice component of claim 9, wherein the applying step is initiated before the heating step.

13. The method for splicing two optical fibers in a fiber optic splice component of claim 9, wherein only one of the applying step and the heating step are performed upon initiating the fiber optic splice machine.

14. The method for splicing two optical fibers in a fiber optic splice component of claim 9, wherein the fiber optic splice machine has a base portion and a top portion, and wherein the top portion closes on the base portion to initiate the fiber optic splice machine.

15. The method for splicing two optical fibers in a fiber optic splice component of claim 9, wherein the inserting step includes inserting the optical fibers into the opening and into physical engagement with one another.

16. The method for splicing two optical fibers in a fiber optic splice component of claim 9, wherein the inserting step includes inserting at least one optical fiber into a clamping mechanism and wherein the fiber optic splice machine further performs causing the clamping mechanism to move the at least one optical fiber into the opening for fusing the optical fibers.

17. The method for splicing two optical fibers in a fiber optic splice component of claim 16, wherein the clamping mechanism is spring driven.

18. The method for splicing two optical fibers in a fiber optic splice component of claim 16, wherein the clamping mechanism is piezo driven.

19. A fiber optic splice machine comprising:
a base portion, the base portion comprising:
a fiber optic splice holder for holding a portion of a fiber optic splice component;
electrical contacts adjacent the fiber optic splice holder and in communication with an arc generator; and
a heating element disposed under the fiber optic splice holder; and
a top portion for covering the base portion and configured to hold a top portion of the fiber optic splice component.

20. The fiber optic splice machine of claim 19, further comprising a battery to energize the arc generator and the heating element.
